(19) United States
(12) Patent Application Publication
(10) Pub. No.: US 2026/0146216 A1
(43) Pub. Date: May 28, 2026

(54) MULTI-USE HEAVY-DUTY CLEANING AND DEGREASING COMPOSITION IN A SOLID DOSE

(71) Applicant: ECOLAB USA INC., Saint Paul, MN (US)

(72) Inventors: Ryan Giffin Moore, Lilburn, GA (US); Emily Olson, Minneapolis, MN (US); Wendy Lo, Woodbury, MN (US)

(21) Appl. No.: 19/396,582

(22) Filed: Nov. 21, 2025

Related U.S. Application Data
(60) Provisional application No. 63/723,677, filed on Nov. 22, 2024.

(51) Int. Cl. C11D 3/39; C11D 1/72; C11D 3/20

(52) U.S. Cl. CPC C11D 3/3942; C11D 1/72; C11D 3/201

(57) ABSTRACT

Solid heavy-duty cleaning compositions including a peroxygen generator, a C4-C6 straight chain saturated alcohol, solidification agent comprising from about 20 wt-% to about 50 wt-% of alkali metal carbonate, and in some embodiments at least one of (i) a nonionic surfactant comprising a linear alkyl alcohol alkoxylate or ethylene oxide/propylene oxide block copolymer, an alkylpolyglycoside, an amine oxide, or combination thereof and/or (ii) a solvent comprising a benzyl alcohol, benzyl alcohol alkoxylate, linear alcohol, and/or glycol ether are disclosed. Methods of cleaning surfaces with a use solution of the solid heavy-duty cleaning compositions are also disclosed.

### CROSS-REFERENCE TO RELATED APPLICATION

This application claims priority under 35 U.S.C. § 119 to Provisional Application U.S. Ser. No. 63/723,677, filed Nov. 22, 2024, which is herein incorporated by reference in its entirety.

### TECHNICAL FIELD

The disclosure relates generally to solid heavy-duty cleaning compositions including a peroxygen generator, a C4-C6 straight chain saturated alcohol, additional solidification agent comprising from about 20 wt-% to about 50 wt-% of alkali metal carbonate, and a nonionic surfactant comprising a linear alkyl alcohol alkoxylate or ethylene oxide/propylene oxide block copolymer, an alkylpolyglycoside, an amine oxide, and optionally a solvent comprising a benzyl alcohol, benzyl alcohol alkoxylate, linear alcohol, and/or glycol ether, and/or a protease enzyme. The disclosure further includes methods of cleaning surfaces with a use solution of the solid heavy-duty cleaning compositions.

### BACKGROUND

Various consumer and industrial applications use cleaning products having a multi-use application. Due to the variety of soils and surfaces and objects that are soiled, there remains a need for cleaning products that provide heavy-duty multi-use cleaning. Most often, heavy-duty cleaning formulations are highly alkaline, including pH greater than at least 12-13. Exemplary applications requiring high alkalinity include for example, removal of greasy soils and burnt on soils in ovens that require strongly alkaline formulas known to present a higher risk to human health. Although efficacious in cleaning, they present safety concerns and therefore the person contacting and using such highly alkaline, heavy-duty cleaning formulations utilizes personal protective equipment (PPE), such as gloves, eye-protection and the like, the requirements for which vary within jurisdictions. For example, in the United States PPE is required for any chemical safety rate more than 2B on eyes and hazardous to skin.

There exists a need in the art for improved heavy-duty cleaning products that are not highly alkaline and require use of PPE. This provides numerous safety benefits and can obviate the requirement for costly equipment such as eye-wash stations.

It is therefore an object of this disclosure to provide heavy-duty cleaning products that are safer to handle as they have a milder pH that is less than or 11.5 (“PPE-Free”) and preferably are free of alkaline metal hydroxides.

It is a further object of the disclosure to provide heavy-duty multi-use cleaning compositions with degreasing functionality.

It is another object of this disclosure to formulate the heavy-duty multi-use cleaning compositions for use as oven cleaners and other applications.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

According to some aspects of the present disclosure, solid heavy-duty cleaning compositions comprise: a peroxygen generator; a C4-C6 straight chain saturated alcohol; additional solidification agents comprising from about 20 wt-% to about 50 wt-% of alkali metal carbonate; and a nonionic surfactant comprising a linear alkyl alcohol alkoxylate or ethylene oxide/propylene oxide block copolymer, an alkylpolyglycoside surfactant, and/or amine oxide surfactant (which is an amphoteric surfactant that is behaving as a nonionic surfactant under neutral to alkaline pH conditions).

According to further aspects of the present disclosure, solid heavy-duty cleaning compositions comprise: a peroxygen generator; a C4-C6 straight chain saturated alcohol; additional solidification agents comprising from about 20 wt-% to about 50 wt-% of alkali metal carbonate; and a nonionic surfactant comprising a linear alkyl alcohol alkoxylate or ethylene oxide/propylene oxide block copolymer, an alkylpolyglycoside surfactant, and/or amine oxide surfactant (which is an amphoteric surfactant that is behaving as a nonionic surfactant under neutral to alkaline pH conditions), and optionally a solvent comprising a benzyl alcohol, benzyl alcohol alkoxylate, linear alcohol, and/or glycol ether, and/or a protease enzyme.

According to some additional aspects of the present disclosure, methods of cleaning a surface or object comprise: contacting the surface or object with a use solution of the solid heavy-duty cleaning compositions as described according to any of the embodiments herein, wherein the use solution has a pH less than or about 11.5.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1D show a performance comparison of the Commercial Control and an exemplary cleaning composition according to the invention (formula 29).

FIGS. 2A-2D show a performance comparison of the cleaning composition according to the invention with varying pH (formulas 28 and 32).

FIGS. 3A-3D show a performance comparison of cleaning compositions containing sorbitol and acid with and without sodium percarbonate (formulas 25 and 27).

FIGS. 4A-4F show a comparison of the degreasing behaviors of the cleaning compositions according to the invention (formulas 32, 33, and 34).

FIGS. 5A-5H show the improved performance of the cleaning composition with degreasing synergy (formulas 25, 29, 32, and 34).

FIGS. 6A-6B show the before and after (respectively) cleaning performance of the cleaning composition with degreasing synergy (formula 6) in field conditions to clean grease traps in a commercial oven.

FIGS. 7A-7B and 8A-8B show the before and after (respectively) cleaning performance of the cleaning composition with degreasing synergy (formula 6) in field conditions to clean grease and soils inside a commercial oven.

Various embodiments of the present disclosure will be described in detail with reference to the figures. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. It has been surprisingly found that a combination of a peroxygen generator and a C4-C6 straight chain saturated alcohol provides unexpected cleaning performance in a solid heavy-duty cleaning composition.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “between” is inclusive of any endpoints noted relative to a described range.

As used herein, the term “cleaning” refers to a method used to facilitate or aid in soil removal, bleaching, microbial population reduction, and any combination thereof.

As used herein, the phrase “consumer” refers to a non-institutional use as well as the purchaser who intends to use a product or a commodity for a non-industrial and business use, such as a use of a product within a consumer's own home.

As used herein, the term “exemplary” refers to an example, an instance, or an illustration, and does not indicate a most preferred embodiment unless otherwise stated.

As used herein, the phrase “food processing surface” refers to a surface of a tool, a machine, equipment, a structure, a building, or the like that is employed as part of a food processing, preparation, or storage activity. Examples of food processing surfaces include surfaces of food processing or preparation equipment (e.g., slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “hard surface” refers to a solid, substantially non-flexible surface such as a counter top, tile, floor, wall, panel, window, plumbing fixture (e.g. drain), kitchen and bathroom fixtures and appliances, dishes, and the like. Hard surfaces are not limited by the material; for example, a hard surface can be glass, metal, tile, vinyl, linoleum, composite, wood, plastic, etc. Hard surfaces may include for example, appliance surfaces, such as ovens, dishwashers, microwaves, drains, grease traps, washing machines, and the like, food processing surfaces, such as beverage towers, and the like.

As used herein, the term “institutional” is meant that the use or operations are located in a commercial or service industry including but not limited to hotels, motels, hospitals, nursing homes, restaurants, health clubs, and the like.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

As used herein, the term “substantially free” refers to compositions completely lacking the component or having such a small amount of the component that the component does not affect the performance of the composition. The component may be present as an impurity or as a contaminant and shall be less than 0.5 wt-%.

The term “surfactant” refers to an organic chemical that when added to a liquid changes the properties of that liquid at a surface.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Heavy-Duty Cleaning Compositions

According to embodiments, the heavy-duty cleaning compositions include a peroxygen generator, a C4-C6 straight chain saturated alcohol, solidification agent(s) comprising alkali metal carbonate, and a surfactant, wherein the surfactant is a nonionic surfactant comprising a linear alkyl alcohol alkoxylate or ethylene oxide/propylene oxide block copolymer, an alkylpolyglycoside surfactant, and/or amine oxide surfactant (which is an amphoteric surfactant that is behaving as a nonionic surfactant under neutral to alkaline pH conditions), and optionally a solvent comprising a benzyl alcohol, benzyl alcohol alkoxylate, linear alcohol, and/or glycol ether, and/or a protease enzyme. The heavy-duty cleaning compositions can include additional functional ingredients and are provided as solid compositions.

Exemplary solid heavy-duty cleaning compositions are shown in Tables 1A and 1B in weight percentage. While the components may have a percent actives of 100%, it is noted that Table 1 does not recite the percent actives of the components, but rather, recites the total weight percentage of the raw materials (i.e. active concentration plus inert ingredients, such as water).

TABLE 1A

| | First | Second | Third |
|---|---|---|---|
| | Exemplary | Exemplary | Exemplary |
| Material | Range wt.-% | Range wt.-% | Range wt.-% |
| Peroxygen generator | 1-40 | 15-40 | 20-40 |
| C4-C6 straight chain | 1-20 | 5-20 | 10-20 |
| saturated alcohol | | | |
| Solidification agents | 20-50 | 25-50 | 30-50 |
| (alkali metal carbonate) | | | |
| Surfactant | 0.1-10 | 0.5-10 | 2-10 |
| Solvent | 0-20 | 0-15 | 0-10 |
| Additional Functional | 0-40 | 0-30 | 0-20 |
| Ingredients | | | |

TABLE 1B

| | First | Second | Third |
|---|---|---|---|
| | Exemplary | Exemplary | Exemplary |
| Material | Range wt.-% | Range wt.-% | Range wt.-% |
| Peroxygen generator | 1-40 | 15-40 | 20-40 |
| C4-C6 straight chain | 1-20 | 5-20 | 10-20 |
| saturated alcohol | | | |
| Solidification agents | 20-50 | 25-50 | 30-50 |
| (alkali metal carbonate) | | | |
| Surfactant | 0.1-10 | 0.5-10 | 2-10 |
| Solvent | 1-20 | 1-15 | 1-10 |
| Additional Functional | 0-40 | 0-30 | 0-20 |
| Ingredients | | | |

### Solid Compositions

The heavy-duty cleaning composition are solid compositions. Solid composition can be in the form of a granular solid, powder, flake, tablet, pellet, puck, briquette, brick, or block. In preferred embodiments, the solid composition is a unit dose tablet or a multi-use solid block, such as a pressed block for dispensing. In further preferred embodiments, the unit dose tablets are either individually wrapped unit doses or are loose tablets in a jar or other container. In further embodiments, the solid compositions can include powder in a bucket. The solid compositions and components contained therein are not encapsulated solids.

Although solid compositions can include a certain amount of water in the composition, either added or as a component of an aqueous raw material in the solid composition, the solid compositions preferably do not add any free water into the solids. In embodiments, the solid compositions contain less than about 10 wt-% water, less than about 5 wt-% water, or preferably less than about 2 wt-% water.

### Peroxygen Generator

The solid heavy-duty cleaning composition comprises a peroxygen generator. In embodiments, the peroxygen generator is a hydrogen peroxide generator. The peroxygen generator can be any source of peroxygen generator that is compatible with the other components of the solid cleaning composition.

Exemplary peroxygen generators include an alkali metal percarbonate, alkali metal persulfate or monopersulfate, an alkaline earth metal peroxide, urea peroxide, alkali metal perborates, hydrogen peroxide, or a combination thereof, and preferably wherein the alkali metals are sodium or potassium.

In preferred embodiments, the peroxygen generator is sodium percarbonate, potassium percarbonate, sodium persulfate, potassium monopersulfate, calcium peroxide, magnesium peroxide, urea peroxide, sodium perborate, potassium perborate, hydrogen peroxide, or a combination thereof. In a further preferred embodiment, the peroxygen generator is sodium percarbonate, potassium percarbonate, or a combination thereof.

As referred to herein, alkali metal percarbonates can further include an expanded percarbonate salt. This is an absorbent base that is useful for absorbing liquid ingredients. The absorption capacity and the ability to absorb larger weights of liquid depends on the carrier's mass, bulk density and porosity. The expanded percarbonate salt can have a bulk density of about 0.62 to 0.7 g/mL and a hydrogen peroxide content of about 0.1 wt-% to less than 24 wt-%. In some preferred embodiments, the expanded percarbonate salt is a dry solid powder. In some embodiments, an expanded percarbonate salt is a percarbonate salt with less than about 24 wt-% of hydrogen peroxide. Beneficially the expanded percarbonate salt can load liquids onto the compound and in embodiments can absorb liquid in an amount up to (or hold up to) about 80 wt-% thereof. Additional disclosure of expanded percarbonate salts is disclosed in U.S. Pat. No. 8,652,434 the contents of which are incorporated herein by reference in their entirety.

In some embodiments, the peroxygen generator is included in solid heavy-duty cleaning composition at an amount of at least about 1 wt-% to about 40 wt-%, about 5 wt-% to about 40 wt-%, about 10 wt-% to about 40 wt-%, about 15 wt-% to about 40 wt-%, about 20 wt-% to about 40 wt-%, or about 25 wt-% to about 40 wt-%. In addition, without being limited according to the disclosure, all ranges recited are inclusive of the numbers defining the range and include each integer within the defined range.

### C4-C6 Straight Chain Saturated Alcohol

The solid heavy-duty cleaning composition comprises a C4-C6 straight chain saturated alcohol. The straight chain saturated alcohol is an active binder within the solid composition and the saturated alcohol chain unexpectedly provides an enhanced boost in cleaning performance (i.e. serving as an “active binder”) in combination with the peroxygen generator instead of acting solely as a binder, such as a tablet binder in compositions without the peroxygen generator. This is unexpected to have enhanced boost in cleaning performance, namely degreasing efficacy.

The C4-C6 straight chain saturated alcohol comprise at least one of sorbitol, mannitol, xylitol, and/or erythritol. In preferred embodiments the C4-C6 straight chain saturated alcohol comprise sorbitol.

In some embodiments, the C4-C6 straight chain saturated alcohol is included in solid heavy-duty cleaning composition at an amount of at least about 1 wt-% to about 30 wt-%, about 1 wt-% to about 20 wt-%, about 2 wt-% to about 20 wt-%, about 5 wt-% to about 20 wt-%, about 10 wt-% to about 20 wt-%, or about 15 wt-% to about 20 wt-%. In addition, without being limited according to the disclosure, all ranges recited are inclusive of the numbers defining the range and includes each integer within the defined range.

### Solidification Agent(s)

The solid heavy-duty cleaning composition comprises solidification agents comprising alkali metal carbonate. The solidification agents provide the alkalinity of the solid compositions to provide mildly alkaline solid compositions. Preferably the alkali metals are sodium or potassium.

In preferred embodiments the solidification agent is free of alkali metal hydroxides.

In some embodiments, the solidification agent(s) comprising alkali metal carbonate is included in solid heavy-duty cleaning composition at an amount of at least about 20 wt-% to about 60 wt-%, about 20 wt-% to about 50 wt-%, about 25 wt-% to about 50 wt-%, or about 30 wt-% to about 50 wt-%. In addition, without being limited according to the disclosure, all ranges recited are inclusive of the numbers defining the range and include each integer within the defined range.

### Surfactants

In some embodiments the solid heavy-duty cleaning composition comprises a nonionic surfactant comprising a linear alkyl alcohol alkoxylate, ethylene oxide/propylene oxide block copolymer, an alkylpolyglycoside surfactant, and/or amine oxide surfactant (which is an amphoteric surfactant that is behaving as a nonionic surfactant under neutral to alkaline pH conditions).

Linear alkyl alcohol alkoxylates can include for example, Plurafac LF-500 (Ethoxylated and Propoxylated Alcohols): alkoxylated, predominately unbranched fatty alcohols, and with higher alkene oxides alongside ethylene oxide), Plurafac LF-221 (Alcohol alkoxylate: C13-C15 branched and linear, butoxylated and ethoxylated alcohols or Plurafac RA300 (fatty alcohol alkoxylate EO or EO/PO surfactant). Additional examples of alcohol alkoxylates can include Dehypon LS-54 (R-(EO)₅(PO) 4) and Dehypon LS-36 (R-(EO)₃(PO)₆); examples of capped alcohol alkoxylates can include Plurafac LF221 and Tegoten EC11.

Further exemplary alcohol alkoxylates are shown in Table 2.

TABLE 2

| | | |
|---|---|---|
| Surfactant A | R¹-O-(EO)ₓ₃(PO)_{y3}-H | wherein R¹ is a straight-chain C₁₀- |
| | | C₁₆ alkyl, wherein x₃ is from 5 to 8, |
| | | and wherein y₃ is from 2 to 5 |
| Surfactant A2 | R¹-O-(EO)ₓ₄(PO)_{y4}-H | wherein R¹ is a straight-chain C₁₀- |
| | | C₁₆ alkyl, wherein x₄ is from 4 to 6, |
| | | and wherein |
| | | y₄ is from 3 to 5 |
| Surfactant B | R²-O-(EO)ₓ₁-H | wherein R² is C₁₀-C₁₄ alkyl with an |
| | | average of at least 2 branches per |
| | | residue, and |
| | | wherein x₁ is from 5 to 10 |
| Surfactant C | R²-O-(EO)ₓ₂-H | wherein R² is C₁₀-C₁₄ alkyl with an |
| | | average of at least 2 branches per |
| | | residue, and wherein x₂ is from 2 to |
| | | 4 |
| Surfactant D | R⁷-O-(PO)y₅(EO)x₅(PO)y₆-H | wherein R⁷ is a branched C₈-C₁₆ |
| | | Guerbet alcohol, x₅ is from 5 to 30, |
| | | y₅ is from 1 to 4, and y₆ is from 10 |
| | | to 20 |
| Surfactant E | R⁶-O-(PO)y₄(EO)x₄-H | wherein R⁶ is a C₈-C₁₆ Guerbet |
| | (R⁶ is C₈-C₁₆-guerbet) | alcohol, wherein x₄ is from 2 to 10, |
| | | and wherein y₄ is from 1 to 2, |

Ethylene oxide/propylene oxide block copolymers, also referred to as EO/PO copolymers are a type of nonionic alkoxylated surfactant which can also include capped EO/PO copolymers. EO/PO block copolymers can include Pluronic and reverse Pluronic surfactants, such as for example, Pluronic F108 an ethylene oxide and propylene oxide block copolymer having an HLB greater than 24, available from BASF.

Alkylpolyglycoside surfactants can also be referred to as alkylpolysaccharide surfactants. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Amine oxides as referred to herein are described with nonionic surfactants as they behave as nonionics in neutral to alkaline solutions, as are generated by the solid compositions described herein. However, amine oxides are understood generally to be amphoteric surfactants. Amine oxide surfactants include tertiary amine oxides corresponding to the general formula:

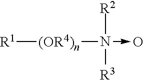

wherein the arrow is a conventional representation of a semi-polar bond; and, R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Water soluble amine oxide surfactants can include coconut or tallow alkyl di-(lower alkyl) amine oxides, specific examples of which are dodecyldimethylamine oxide, tridecyldimethylamine oxide, etradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Additional amine oxide surfactants include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl)amine oxides, specific examples of which are octyldimethylamine oxide, nonyldimethylamine oxide, decyldimethylamine oxide, undecyldimethylamine oxide, dodecyldimethylamine oxide, iso-dodecyldimethyl amine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl) dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

In some embodiments, the surfactant is included in solid heavy-duty cleaning composition at an amount of at least about 0 wt-% to about 10 wt-%, or about 0 wt-% to about 5 wt-%. In addition, without being limited according to the disclosure, all ranges recited are inclusive of the numbers defining the range and include each integer within the defined range.

In further embodiments, the surfactant is included in solid heavy-duty cleaning composition at an amount of at least about 0.1 wt-% to about 10 wt-%, about 0.5 wt-% to about 10 wt-%, or about 2 wt-% to about 10 wt-%, or further in an amount of at least about 0.1 wt-% to about 10 wt-%, about 0.5 wt-% to about 5 wt-%, or about 1 wt-% to about 5 wt-%. In addition, without being limited according to the disclosure, all ranges recited are inclusive of the numbers defining the range and include each integer within the defined range.

### Solvent

In some embodiments the solid heavy-duty cleaning composition comprises a solvent comprising a benzyl alcohol, benzyl alcohol alkoxylate, linear alcohol, and/or glycol ether. Preferred alkoxylates as referred to herein are ethoxylates. In some embodiments the solid heavy-duty cleaning composition comprises a solvent comprising a benzyl alcohol, benzyl alcohol ethoxylate (e.g. Genapol BA040), linear alcohol, and/or glycol ether solvents. Beneficially the solvent provides additional degreasing performance for the compositions.

Glycol ethers have the formula: Rₐ—O—R_{b}—OH wherein R^{a} is an alkyl of 1 to 20 carbon atoms, or an aryl of at least 6 carbon atoms and R_{b} is an alkylene of 1 to 8 carbons or is an ether or polyether containing from 2 to 20 carbon atoms.

Examples of suitable glycol ether solvents include ethylene glycol monobutyl ether (butyl cellosolve), diethylene glycol monobutyl ether (butyl carbitol), triethylene glycol monobutyl ether, mono-, di-, tri-propylene glycol monobutyl ether, tetraethylene glycol monobutyl ether, mono-, di-, tri-propylene glycol monomethyl ether, propylene glycol monomethyl, ether, ethylene glycol monohexyl ether, diethylene glycol monohexyl ether, propylene glycol tertiary butyl ether, ethylene glycol monoethyl ether, ethylene glycol monomethyl ether, ethylene glycol monopropyl ether, ethylene glycol monopentyl ether, diethylene glycol monomethyl ether, diethylene glycol monoethyl ether, diethylene glycol monopropyl ether, diethylene glycol monopentyl ether, triethylene glycol monomethyl ether, triethylene glycol monoethyl ether, triethylene glycol monopropyl ether, triethylene glycol monopentyl ether, triethylene glycol monohexyl ether, mono-, di-, tri-propylene glycol monoethyl ether, mono-, di-, tri-propylene glycol monopropyl ether, mono-, di-, tri-propylene glycol monopentyl ether, mono-, di-, tri-propylene glycol monohexyl ether, mono-, di-, tri-butylene glycol mono methyl ether, mono-, di-, tri-butylene glycol monoethyl ether, mono-, di-, tri-butylene glycol monopropyl ether, mono-, di-, tri-butylene glycol monobutyl ether, mono-, di-, tri-butylene glycol monopentyl ether, mono-, di-, tri-butylene glycol monohexyl ether, ethylene glycol monoacetate and dipropylene glycol propionate and mixtures thereof. Preferred examples include 1-methoxy-2-propanol (e.g. Dowanol PM) and 3-butoxypropan-2-ol (e.g. Dowanol PnB).

Other solvents include water-miscible alcohols, especially C1-4 alcohols, optionally substituted with a C1-4 alkoxy group, such as ethanol, propanol, butanol, isopropanol, and mixtures thereof. In a preferred embodiment benzyl alcohol is a preferred aromatic solvent. In some embodiments, the solvent is included in solid heavy-duty cleaning

composition at an amount of at least about 0 wt-% to about 20 wt-%, about 0 wt-% to about 15 wt-%, or about 0 wt-% to about 10 wt-%. In addition, without being limited according to the disclosure, all ranges recited are inclusive of the numbers defining the range and includes each integer within the defined range.

In some embodiments the solvent is not required for the solid heavy-duty cleaning composition or is not included in a significant amount due to limitations of formulation in the tablet or solid composition. However, in embodiments a solvent is included and provides improved performance with the surfactants.

In further embodiments, the solvent is included in solid heavy-duty cleaning composition at an amount of at least about 1 wt-% to about 20 wt-%, about 1 wt-% to about 15 wt-%, about 1 wt-% to about 10 wt-%, or about 5 wt-% to about 15 wt-%, or about 5 wt-% to about 10 wt-%. In addition, without being limited according to the disclosure, all ranges recited are inclusive of the numbers defining the range and includes each integer within the defined range.

### Additional Functional Ingredients

The components of the solid heavy-duty cleaning composition can further be combined with various functional components suitable for uses disclosed herein. In some embodiments, the solid heavy-duty cleaning compositions including the peroxygen generator, C4-C6 straight chain saturated alcohol, solidification agent(s) comprising alkali metal carbonate, and at least one of (i) a surfactant comprising a linear alkyl alcohol alkoxylate or ethylene oxide/propylene oxide block copolymer, an alkylpolyglycoside surfactant, and/or amine oxide surfactant) and/or (ii) a solvent comprising benzyl alcohol, benzyl alcohol alkoxylate, linear alcohol, and/or glycol ether make up a large amount, or even substantially all of the total weight of the compositions. For example, in some embodiments few or no additional functional ingredients are disposed therein.

The components of the solid heavy-duty cleaning composition can further be combined with various functional components suitable for uses disclosed herein. In some embodiments, the solid heavy-duty cleaning compositions including the peroxygen generator, C4-C6 straight chain saturated alcohol, solidification agent(s) comprising alkali metal carbonate, and a surfactant comprising a linear alkyl alcohol alkoxylate or ethylene oxide/propylene oxide block copolymer, an alkylpolyglycoside surfactant, and/or amine oxide surfactant), and optionally a solvent comprising benzyl alcohol, benzyl alcohol alkoxylate, linear alcohol, and/or glycol ether, and/or a protease enzyme, make up a large amount, or even substantially all of the total weight of the compositions. For example, in some embodiments few or no additional functional ingredients are disposed therein.

In other embodiments, additional functional ingredients may be included in the solid heavy-duty cleaning compositions. The functional ingredients provide desired properties and functionalities to the compositions. For the purpose of this application, the term “functional ingredient” includes a material that when dispersed or dissolved in a use solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the solid heavy-duty cleaning composition may include a peroxycarboxylic acid generator.

In other embodiments, the solid heavy-duty cleaning composition may include peroxycarboxylic acid generator or a peroxycarboxylic acid, bleach catalysts, additional alkalinity sources, acetate salts, alkali metal gluconates, such as sodium gluconate, acid source, defoaming agents, anti-redeposition agents, bleaching agents, solubility modifiers, dispersants, metal protecting agents, soil antiredeposition agents, stabilizing agents, corrosion inhibitors, chelant, aesthetic enhancing agents including fragrances and/or dyes, enzymes (e.g. protease enzymes), additional rheology and/or solubility modifiers or thickeners, hydrotropes or couplers, buffers, solvents, additional cleaning agents and the like.

According to embodiments of the disclosure, the various additional functional ingredients may be provided in a solid heavy-duty cleaning composition in the amount from about 0 wt-% and about 40 wt-%, from about 0 wt-% and about 35 wt-%, from about 0 wt-% and about 30 wt-%, from about 0 wt-% and about 25 wt-%, from about 0 wt-% and about 20 wt-%, from about 0.1 wt-% and about 40 wt-%, from about 0.1 wt-% and about 35 wt-%, from about 0.1 wt-% and about 30 wt-%, from about 0.1 wt-% and about 25 wt-%, from about 0.1 wt-% and about 20 wt-%, or from about 1 wt-% and about 40 wt-%, from about 1 wt-% and about 35 wt-%, from about 1 wt-% and about 30 wt-%, from about 1 wt-% and about 25 wt-%, from about 1 wt-% and about 20 wt-%. In addition, without being limited according to the disclosure, all ranges recited are inclusive of the numbers defining the range and include each integer within the defined range.

In preferred embodiments, the solid heavy-duty cleaning composition is free of alkali metal hydroxides. In further preferred embodiments, the solid heavy-duty cleaning composition is free of alkyl ketal esters, alkyl ether sulfates, enzymes and/or spores, or combinations thereof. In further preferred embodiments, the solid heavy-duty cleaning composition is free of alkyl ketal esters, alkyl ether sulfates, enzymes and/or spores, alkali metal hydroxides, or combinations thereof. According to embodiments free of enzymes and/or spores, the use of the peroxygen generator, namely to produce hydrogen peroxide in the use solution, would kill or deactivate any biologics and degrade any enzymes.

In still further embodiments the compositions can exclude the use of any non C4-C6 straight chain saturated alcohols, or any non C4-C6 polyols, which are often used in solid compositions as sugar/saccharides for certain tableting and/or binding effects.

### Peroxycarboxylic Acid Generator

In some embodiments the solid heavy-duty cleaning composition comprises a peroxycarboxylic acid generator. Examples of peroxycarboxylic acid generators include monoacetin, diacetin, triacetin, glucose pentaacetate, lactose octaacetate, mannitol hexaacetate, sucrose octaacetate, N,N,N′N′-tetraacetylethylene-diamine (TAED), N,N,N′N′-tetraacetylmethylene-diamine (TAMD), N-acetyl glycine, N-acetyl-methionine, 6-acetamidohexanoic acid, N-acetyl-L-cysteine, 4-acetamido-phenol, N-acetyl-L-glutamine, and N,N′,N″,N′″-tetraacetyl glycoluril (TAGU), and/or lactide. In a preferred embodiment the peroxycarboxylic acid generator is N,N,N′N′-tetraacetylethylene-diamine (TAED).

The peroxycarboxylic acid generator can be coupled to solid cleaning compositions by any of a variety of methods for coupling one solid cleaning composition to another. In preferred embodiments the peroxycarboxylic acid generator is formulated in the solid compositions as part of a homogenous solid composition.

In some embodiments, the peroxycarboxylic acid generator is included in solid heavy-duty cleaning composition at an amount of at least about 0 wt-% to about 10 wt-%, or about 0.1 wt-% to about 10 wt-%. In addition, without being limited according to the disclosure, all ranges recited are inclusive of the numbers defining the range and include each integer within the defined range.

### Additional Alkalinity Sources

In embodiments, where additional alkalinity sources are included, in addition to the solidification agents that provide alkalinity, it is understood that these do not include alkali metal hydroxides. Examples of alkaline sources include, but are not limited to carbonate-based alkalinity sources of the solidification agent, including, for example, carbonate salts such as alkali metal carbonates. Additional alkalinity sources can include metal silicate, metal borate, and organic alkalinity sources. Exemplary metal silicates that can be used include, but are not limited to, sodium or potassium silicate or metasilicate. Exemplary metal borates include, but are not limited to, sodium or potassium borate. Organic alkalinity sources are often strong nitrogen bases including, for example, ammonia (ammonium hydroxide), amines, alkanolamines, and amino alcohols. Typical examples of amines include primary, secondary or tertiary amines and diamines carrying at least one nitrogen linked hydrocarbon group, which represents a saturated or unsaturated linear or branched alkyl group having at least 10 carbon atoms and preferably 16-24 carbon atoms, or an aryl, aralkyl, or alkaryl group containing up to 24 carbon atoms, and wherein the optional other nitrogen linked groups are formed by optionally substituted alkyl groups, aryl group or aralkyl groups or polyalkoxy groups. Typical examples of alkanolamines include monoethanolamine, monopropanolamine, diethanolamine, dipropanolamine, triethanolamine, tripropanolamine and the like. Typical examples of amino alcohols include 2-amino-2-methyl-1-propanol, 2-amino-1-butanol, 2-amino-2-methyl-1,3-propanediol, 2-amino-2-ethyl-1,3-propanediol, hydroxymethyl aminomethane, and the like.

In some embodiments, the additional alkalinity source is included in solid heavy-duty cleaning composition at an amount of at least about 0 wt-% to about 40 wt-%, about 0.1 wt-% to about 40 wt-%, about 1 wt-% to about 40 wt-%, about 1 wt-% to about 30 wt-%, or about 1 wt-% to about 20 wt-%. In addition, without being limited according to the disclosure, all ranges recited are inclusive of the numbers defining the range and include each integer within the defined range.

### Chelants

In embodiments, chelants can be included in the solid heavy-duty cleaning compositions. Often, the cleaning composition is also phosphate-free and/or sulfate-free. In embodiments of the solid cleaning composition that are phosphate-free, the additional functional materials, including chelants exclude phosphorous-containing compounds such as condensed phosphates and phosphonates.

Suitable additional chelants include aminocarboxylates and polycarboxylates. Some examples of aminocarboxylates useful as chelating/sequestering agents, include, N-hydroxyethyliminodiacetic acid, nitrilotriacetic acid (NTA), ethylenediaminetetraacetic acid (EDTA), N-hydroxyethyl-ethylenediaminetriacetic acid (HEDTA) (in addition to the HEDTA used in the binder), diethylenetriaminepentaacetic acid (DTPA), methylglycine diacetic acid (MGDA), glutamic acid diacetic acid (GLDA), and the like. Some examples of polymeric polycarboxylates suitable for use as sequestering agents include those having a pendant carboxylate (—CO₂) groups and include, for example, polyacrylic acid, maleic/olefin copolymer, acrylic/maleic copolymer, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like.

In embodiments of the solid cleaning composition which are not phosphate-free, added chelants may include, for example a condensed phosphate, a phosphonate, and the like. Some examples of condensed phosphates include sodium and potassium orthophosphate, sodium and potassium pyrophosphate, sodium tripolyphosphate, sodium hexametaphosphate, and the like. A condensed phosphate may also assist, to a limited extent, in solidification of the composition by fixing the free water present in the composition as water of hydration.

In embodiments of the solid cleaning composition which are not phosphate-free, the composition may include a phosphonate such as 1-hydroxyethane-1,1-diphosphonic acid CH₃C(OH)[PO(OH)₂]₂; aminotri(methylenephosphonic acid) N[CH₂PO(OH)₂]₃; aminotri(methylenephosphonate), sodium salt

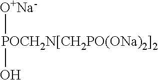

2-hydroxyethyliminobis(methylenephosphonic acid) HOCH₂CH₂N[CH₂PO(OH)₂]₂; diethylenetriaminepenta(methylenephosphonic acid) (HO)₂POCH₂N [CH₂N [CH₂PO(OH)₂]₂]₂; diethylenetriaminepenta(methylenephosphonate), sodium salt C₉H₍₂₈₋ₓ₎ N₃NaₓO₁₅P₅ (x=7); hexamethylenediamine (tetramethylenephosphonate), potassium salt C₁₀H₍₂₈₋ₓ₎N₂KₓO₁₂P₄ (x=6); bis(hexamethylene)triamine (pentamethylenephosphonic acid) (HO₂) POCH₂N [(CH₂)₆N [CH₂PO(OH)₂]₂]₂; and phosphorus acid H₃PO₃. In some embodiments, a phosphonate combination such as ATMP and DTPMP may be used. A neutralized or alkaline phosphonate, or a combination of the phosphonate with an alkali source prior to being added into the mixture such that there is little or no heat or gas generated by a neutralization reaction when the phosphonate is added can be used.

For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

In some embodiments, the chelants are included in solid heavy-duty cleaning composition at an amount of at least about 0 wt-% to about 20 wt-%, about 0.1 wt-% to about 20 wt-%, or about 1 wt-% to about 20 wt-%. In addition, without being limited according to the disclosure, all ranges recited are inclusive of the numbers defining the range and include each integer within the defined range.

### Acid Source

In embodiments, an acid source(s) can be included in the solid heavy-duty cleaning compositions. Preferably the acid is a polycarboxylic acid. More preferably, the acid is a polycarboxylic acid having between 2 and 4 carboxyl groups. More preferably the polycarboxylic acid is a dicarboxylic acid or a tricarboxylic acid. Preferred acids include, but are not limited to, citric acid, adipic acid, ethylenediamine tetra acetic acid, isocitric acid, glutamic acid, glutaric acid, malic acid, propane-1,2,3-tricarboxylic acid, succinic acid, tartaric acid, salts of the foregoing, and mixtures thereof.

In some embodiments, the acid source(s) are included in solid heavy-duty cleaning composition at an amount of at least about 0 wt-% to about 10 wt-%, about 0.1 wt-% to about 10 wt-%, or about 1 wt-% to about 5 wt-%. In addition, without being limited according to the disclosure, all ranges recited are inclusive of the numbers defining the range and include each integer within the defined range.

### Acetate Salts

The solid compositions can further comprise acetate salts.

In some applications, a water soluble acetate salt is preferred. The acetate salt can be a water soluble acetate salt in anhydrous form. In some applications, the acetate is an anhydrous salt of an alkali metal. Preferred among these are the anhydrous sodium acetate salts and potassium acetate salts. In some applications, the acetate is an anhydrous salt of an alkaline earth metal. Preferred among these are the anhydrous calcium acetate salts and magnesium acetate salts. In some applications, the anhydrous acetate salt composition is selected from among sodium acetate, potassium acetate, calcium acetate, magnesium acetate, sodium diacetate, potassium diacetate and combinations thereof. Acetate salts, including anhydrous forms of acetate salts, are commercially available (e.g., from Niacet Corporation, Niagara Falls, N.Y.; Chem One Ltd., Houston, Tex., USA; Vasa Pharmachem Pvt. Ltd., Gujarat, India; and J&K Scientific GmbH, Pforzheim, Germany).

In some embodiments, the acetate salt is included in the tablet composition at an amount of at least about 0 wt-% to about 20 wt-%, about 1 wt-% to about 20 wt-%, about 1 wt-% to about 10 wt-%, or about 2 wt-% to about 10 wt-%. In addition, without being limited according to the disclosure, all ranges recited are inclusive of the numbers defining the range and include each integer within the defined range.

### C6 Saccharide Derivative Sequestrants

The solid compositions can further comprise C6 saccharide derivative sequestrants. A C6 saccharide derivative sequestrant refers to an amino derivative or a hydrogenated or an oxidized derivative of a sugar that contains six C atoms (aldohexoses and ketohexoses). Exemplary of the C6 saccharide derivative sequestrants are the amino hexoses, hexitols, aldonic acids and salts thereof, aldonic acid lactones and salts thereof, hexose-8-lactones and salts thereof, and saccharic acids and salts thereof.

As used herein, “amino hexose” refers to a sugar or saccharide having six C atoms that contains an amino group in place of a hydroxyl group. Glucosamine, galactosamine, mannosamine and derivatives of amino containing sugars, such as N-acetylglucosamine, N-acetyl mannosamine and N-acetyl galactosamine are examples of amino hexoses. As used herein, “hexitol” refers to a sugar containing six C atoms in which the aldehyde or ketone group has been reduced (hydrogenated) to an alcohol. Examples of hexitols include allitol, altritol (talitol), fucitol, galactitol (dulcitol), glucitol (sorbitol), iditol, and mannitol. As used herein, an “aldonic acid” refers to any one of a family of sugar acids obtained by oxidation of the aldehyde functional group of an aldose to form a carboxylic acid functional group. As used herein, an “aldonic acid lactone” refers to a lactone of an aldonic acid. The term “lactone” refers a cyclic ester that is the condensation product of a hydroxy group and a carboxylic acid group in the same molecule. As used herein, a “saccharic acid” refers to an oxidized sugar usually produced by oxidizing a sugar with nitric acid, resulting in a compound having the formula C6H10O8. In this oxidized form of sugar, the carbon atom bearing the primary hydroxyl group and the aldehydic carbon atom are oxidized to carboxylic acid groups.

Exemplary sequestrants include for example an oxidized C6 saccharide that is an aldonic acid lactone. Exemplary aldonic acid lactones include allonolactone, altronolactone, gluconolactone, mannolactone, gulonolactone, idonolactone, galactonolactone, talonolactone. In some applications, the C6 saccharide derivative sequestrant is or contains an aldonic acid lactone selected from among gluconolactone, mannolactone, gulonolactone and galactonolactone and combinations thereof. In some applications, the C6 saccharide derivative sequestrant is or contains a gluconolactone. The C6 saccharide derivative sequestrant can contain one or more aldonic acid lactones in combination with another C6 saccharide derivative sequestrant. Additional examples of exemplary C6 saccharides are set forth in U.S. Pat. No. 11,136,537 which is incorporated herein by reference in its entirety.

In some embodiments, the C6 saccharide derivative sequestrants is included in the tablet composition at an amount of at least about 0 wt-% to about 10 wt-%, about 1 wt-% to about 10 wt-%, about 1 wt-% to about 5 wt-%, or about 2 wt-% to about 5 wt-%. In addition, without being limited according to the disclosure, all ranges recited are inclusive of the numbers defining the range and include each integer within the defined range.

### Methods of Use

The solid heavy-duty cleaning compositions are suited for cleaning a variety of surfaces and objects. The cleaning compositions are efficacious in cleaning and removing various types of challenging soils from such surfaces and objects, including for example fatty and proteinaceous soils, organic soils, and others. In a particular embodiment, the heavy-duty cleaning compositions are efficacious in challenging soils without the use of personal protective equipment (PPE).

In some aspects, the heavy-duty cleaning compositions are useful for removing soils from various surfaces and object in a variety of settings, both institutional and consumer.

Exemplary surfaces can include a hard surface, an oven, a fryer, a dishwasher, a drain, a grease trap, a washing machine, a beverage tower, a coffeemaker, a microwave, a carpet or other soiled surface, a ware, or combinations thereof. In addition, objects within the various surfaces may also be cleaned using the heavy-duty cleaning compositions.

Exemplary industries in which the methods of the present disclosure can be applied include, but are not limited to: retail, institutional and consumer food production industries, restaurants, the food and beverage industry, textile care and laundry industries, various manufacturing industries, consumer uses and markets, and the like.

The methods of using the solid heavy-duty cleaning compositions include applying or contacting a use solution of the compositions to the surface or object. A use solution is generated by dissolving the solid composition in water. The solids can include various forms, including a granular solid, powder, flake, tablet, pellet, puck, briquette, brick, or block. In embodiments the solid compositions are dissolved quickly in water to generate the use solution, e.g. a few minutes, preferably less than about 15 minutes. In further embodiments the dosing, dissolving to provide a use solution, and use therefore can be completed in a period of time less than about 1 hour.

In some embodiments, the use solution is generated in a container that is subsequently used to dispense or otherwise apply the use solution to the surface or object. In an embodiment, the container is a spray bottle. The use solution can be generated by adding a single solid, e.g. tablet or puck, into the container, or a plurality of the solids, e.g. 2-10 or more single solid tablets or the like, and combining with water. In other embodiments, the container is a bucket and a solid, e.g. powder, is added thereto and combined with water. In other embodiments, the container is a solid block dispenser for single or multi use dispensing.

The heavy-duty cleaning compositions can be applied at a use solution pH less than or about 11.5. In preferred embodiments the use solution is from about 10.7 to about 11.5. Beneficially, the use solution pH of the solid heavy-duty cleaning compositions do not require use of PPE.

The use solution of the heavy-duty cleaning compositions can be applied to surfaces or objects using a variety of methods. These methods can operate on an object, surface, or the like, by contacting the object or surface with the composition. Contacting can comprise any of numerous methods for applying a liquid, such as spraying the compound, immersing the object in the compound, or a combination thereof. Without being limited to the contacting according to the disclosure, a use solution of the heavy-duty cleaning composition can be applied to or brought into contact with an object or surface by any conventional method or apparatus for applying a liquid composition to an object or surface. For example, the surface or object can be wiped with (e.g. soaked on a rag or other substrate and wiped onto a surface or object), sprayed with (e.g. used with a trigger sprayer), foamed on, and/or immersed in the use solution. In addition, the contacting can be manual or by machine. Such methods of contacting are particularly useful for CIP processes in ovens, or fryer cleanings (both manual and boil out).

The use solution of the heavy-duty cleaning compositions is in contact with a surface or object for a sufficient amount of time to clean the surface or object. In an aspect, the surface or object is contacted with the acidic cleaning composition for at least about 10 seconds, at least about 30 seconds, at least about 1 minute, at least about 10 minutes, or between about 10 minutes and about 30 minutes.

The use solution of the heavy-duty cleaning compositions can be applied at a use concentration to a surface or object in need of cleaning. In an aspect, a use concentration of the heavy-duty cleaning compositions can be from about 0.5 oz/gal to about 12 oz/gal to provide desired efficacy against various heavy-duty soils.

In an aspect, a use concentration of the heavy-duty cleaning compositions resulting from the about 0.5 oz/gal to about 12 oz/gal dilution includes from about 3,900 ppm to about 93,750 ppm, or from about 5,000 ppm to about 90,000 ppm, or from about 10,000 ppm to about 80,000 ppm of the cleaning composition, including all ranges therebetween.

In a further aspect, a use concentration of the heavy-duty cleaning compositions is preferably from about 2% to about 10% after dilution, or from about 2% to about 8% after dilution, or from about 3.5% to about 6.5% after dilution to provide desired efficacy against various heavy-duty soils.

In further embodiments, the method of use further comprising rinsing the surface with water before and/or after applying the use solution of the heavy-duty cleaning composition.

Beneficially, the methods of using the heavy-duty cleaning composition provides substantially similar cleaning performance to a cleaning composition having an alkaline pH above about 11.5, requiring use of personal protective equipment (PPE), and/or not including the synergistic combination of the peroxygen generator and the C4-C6 straight chain saturated alcohol. In preferred embodiments, the methods of using the heavy-duty cleaning composition provides improved cleaning performance to a cleaning composition having an alkaline pH above about 11.5, requiring use of personal protective equipment (PPE), and/or not including the synergistic combination of the peroxygen generator and the C4-C6 straight chain saturated alcohol. As referred to herein, improved cleaning performance refers to removal of a greater amount of soils on the surface or object.

As a further benefit according to the methods of using the heavy-duty cleaning composition, the use solutions with a pH of less than about 11.5 do not have the same inherent corrosive qualities as alkaline metal hydroxides. Accordingly, the use of the use solutions described herein can further protect the surfaces or objects treated that are made up of metals.

### EMBODIMENTS

The present disclosure is further defined by the following numbered embodiments:

1. A solid heavy-duty cleaning composition comprising: a peroxygen generator; a C4-C6 straight chain saturated alcohol; solidification agents comprising from about 20 wt-% to about 50 wt-% of alkali metal carbonate; and at least one of (i) a nonionic surfactant comprising a linear alkyl alcohol alkoxylate or ethylene oxide/propylene oxide block copolymer, an alkylpolyglycoside surfactant, and/or amine oxide surfactant and/or (ii) a solvent comprising a benzyl alcohol, benzyl alcohol alkoxylate, linear alcohol, and/or glycol ether.

1. A solid heavy-duty cleaning composition comprising: a peroxygen generator; a C4-C6 straight chain saturated alcohol; solidification agents comprising from about 20 wt-% to about 50 wt-% of alkali metal carbonate; and a nonionic surfactant comprising a linear alkyl alcohol alkoxylate or ethylene oxide/propylene oxide block copolymer, an alkylpolyglycoside surfactant, and/or amine oxide surfactant.

2. The composition of embodiment 1, wherein the peroxygen generator is a hydrogen peroxide generator.

3. The composition of any one of embodiments 1-2, wherein the peroxygen generator comprises an alkali metal percarbonate, an expanded percarbonate alkali metal salt, alkali metal persulfate or monopersulfate, an alkaline earth metal peroxide, urea peroxide, alkali metal perborates, hydrogen peroxide, or a combination thereof, and preferably wherein the alkali metals are sodium or potassium.

4. The composition of any one of embodiments 1-3, wherein the solid composition comprises from about 1 wt-% to about 40 wt-% of the peroxygen generator.

5. The composition of any one of embodiments 1-4, wherein the C4-C6 straight chain saturated alcohol comprises at least one of sorbitol, mannitol, xylitol, and/or erythritol.

6. The composition of any one of embodiments 1-5, wherein the solid composition comprises from about 1 wt-% to about 20 wt-% of the C4-C6 straight chain saturated alcohol.

7. The composition of any one of embodiments 1-6, wherein (i) the peroxygen generator is sodium percarbonate, potassium percarbonate, sodium persulfate, potassium monopersulfate, calcium peroxide, magnesium peroxide, urea peroxide, sodium perborate, potassium perborate, hydrogen peroxide, or a combination thereof, and the C4-C6 straight chain saturated alcohol is sorbitol, or (ii) the peroxygen generator is sodium percarbonate, potassium percarbonate, or a combination thereof, and the C4-C6 straight chain saturated alcohol is sorbitol.

8. The composition of any one of embodiments 1-7, wherein the solid composition comprises from about 0.5 wt-% to about 5 wt-% of the nonionic surfactant, or optionally wherein the solid composition comprises from about 1 wt-% to about 10 wt-% of the solvent.

9. The composition of any one of embodiments 1-8, further comprising a solvent comprising a benzyl alcohol, benzyl alcohol alkoxylate, linear alcohol, and/or glycol ether.

10. The composition of embodiment 9, wherein the solid composition comprises from about 1 wt-% to about 10 wt-% of the solvent.

11. The composition of any one of embodiments 1-10, further comprising a peroxycarboxylic acid generator, preferably wherein the peroxycarboxylic acid generator comprises monoacetin, diacetin, triacetin, glucose pentaacetate, lactose octaacetate, mannitol hexaacetate, sucrose octaacetate, N,N,N′N′-tetraacetylethylene-diamine (TAED), N,N,N′N′-tetraacetylmethylene-diamine (TAMD), N-acetyl glycine, N-acetyl-methionine, 6-acetamidohexanoic acid, N-acetyl-L-cysteine, 4-acetamido-phenol, N-acetyl-L-glutamine, and N,N′,N″,N′″-tetraacetyl glycoluril (TAGU), and/or lactide, or more preferably wherein the peroxycarboxylic acid generator is N,N,N′N′-tetraacetylethylene-diamine (TAED).

12. The composition of embodiment 11, wherein the solid composition comprises from about 0.1 wt-% to about 10 wt-% of the peroxycarboxylic acid generator.

13. The composition of any one of embodiments 1-12, wherein the peroxygen generator comprises an alkali metal percarbonate and an expanded percarbonate salt with a bulk density of about 0.62 to 0.7 g/ml and a hydrogen peroxide content of about 0.1 to 24 wt-%, preferably wherein the alkali metal percarbonate and the expanded percarbonate salt comprise from about 1 wt-% to about 40 wt-% of the solid composition, preferably from about 20 wt-% to about 40 wt-% of the solid composition.

14. The composition of any one of embodiments 1-13, wherein the peroxygen generator comprises from about 1 wt-% to about 40 wt-%, preferably from about 20 wt-% to about 40 wt-% of the solid composition, wherein the C4-C6 straight chain saturated alcohol comprises from about 1 wt-% to about 20 wt-%, preferably from about 10 wt-% to about 20 wt-% of the solid composition, wherein the nonionic surfactant comprises from about 0.1 wt-% to about 10 wt-%, from about 2 wt-% to about 10 wt-%, preferably from about 1 wt-% to about 5 wt-% of the solid composition, and wherein the solvent comprises from about 0 wt-% to about 20 wt-%, preferably from about 0 wt-% to about 10 wt-% of the solid composition.

15. The composition of any one of embodiments 1-14, wherein the solid composition further comprises additional functional ingredients, and/or wherein the solid composition is a hard surface cleaner, degreaser, oven cleaner, dishwasher cleaner, drain cleaner, grease trap cleaner, washing machine cleaner, beverage tower cleaner, coffeemaker cleaner, microwave cleaner, carpet cleaner, and/or stain remover.

16. The composition of any one of embodiments 1-14, wherein the solid composition is a granular solid, powder, flake, tablet, pellet, puck, briquette, brick, or block, and preferably wherein the solid composition is a unit dose tablet or a multi-use solid block.

17. The composition of any one of embodiments 1-16, wherein the solid composition is free of alkyl ketal esters, alkyl ether sulfates, enzymes and/or spores, alkali metal hydroxides, or combinations thereof.

18. A method of cleaning a surface or object comprising: contacting the surface or object with a use solution of the solid heavy-duty cleaning composition of any one of embodiments 1-17, wherein the use solution has a pH less than or about 11.5.

19. The method of embodiment 18, wherein the use solution is from about 10.7 to about 11.5.

20. The method of any one of embodiments 18-19, wherein the surface comprises a hard surface, an oven, a fryer, a dishwasher, a drain, a grease trap, a washing machine, a beverage tower, a coffeemaker, a microwave, a carpet or other soiled surface, a ware, or combinations thereof, and/or wherein the object is in contact with the surface.

21. The method of any one of embodiments 18-20, wherein the use solution is generated by dissolving the solid composition in water, and wherein the use solution is between about 0.5 oz/gal to about 12 oz/gal to provide desired efficacy against various heavy-duty soils or wherein the use solution is from about 2% to about 10% use dilution of the solid composition.

22. The method of embodiment 21, wherein the use solution comprises from about 3,900 ppm to about 93,750 ppm, from about 5,000 ppm to about 90,000 ppm, or from about 10,000 ppm to about 80,000 of the solid heavy-duty cleaning composition.

23. The method of any one of embodiments 21-22, wherein the use solution is generated in a container that is subsequently used to dispense or otherwise apply the use solution to the surface or object.

24. The method of any one of embodiments 18-23, further comprising rinsing the surface with water.

25. The method of any one of embodiments 18-24, wherein the heavy-duty cleaning composition provides substantially similar or improved cleaning performance to a cleaning composition having an alkaline pH above about 11.5, requiring use of personal protective equipment (PPE), and/or not including the synergistic combination of the peroxygen generator and the C4-C6 straight chain saturated alcohol.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following ingredients are utilized in the Examples:
Ethylenediaminetetraacetic acid (EDTA).
Expanded sodium percarbonate (ESPC) is an expanded percarbonate salt with a bulk density between about 0.62 to 0.7 g/mL and a hydrogen peroxide content of about 0.1 wt-% to less than 24 wt-%.
Linear alcohol C9-11 with 6 moles E.O.
N,N,N′N′-tetraacetylethylene-diamine (TAED).
PEG 8000-a polyethylene glycol compound with an average molecular weight of 8,000 g/mol.
Pluronic F108—a polyoxypropylene polyoxyethylene block copolymer commercially available from BASF, (F108).
Tomadol 91-6—nonionic ethoxylated alcohol surfactant commercially available from Evonik Industries.
Chelant: Trisodium dicarboxymethyl alaninate (MGDA or Trilon M).
Glucopon 425—an alkyl polyglycoside.
Plurafac SLF-180—C10 (2-Propylheptyl) Alcohol, Alkoxylate.
Additional materials as described.

### Example 1

Exemplary formulations were evaluated to assess the combination of a peroxygen source with a C4-C6 straight chain saturated alcohol and/or surfactants and/or solvents in a solid composition for efficacy in cleaning. Initial screening tests assessed the combination of sodium percarbonate as a hydrogen peroxide generator with a benzyl alcohol solvent, a C4-C6 straight chain saturated alcohol, and/or additional surfactants provided initial results that were at least as effective as hydroxide-based highly alkaline cleaning compositions. Table 3 shows exemplary components in a cleaning composition according to the invention that were compared to a commercial control product using sodium and potassium hydroxides with a pH of 13.6.

TABLE 3

| | Formulas | | | | |
|---|---|---|---|---|---|
| | 1 | 2 | 3 | 4 | 5 |
| Components | (wt-%) | (wt-%) | (wt-%) | (wt-%) | (wt-%) |
| Benzyl Alcohol | 17.8 | 12.3 | — | — | — |
| Sodium carbonate and | 82.2 | 56.9 | 62 | 60.5 | 60.5 |
| Sodium percarbonate | | | | | |
| (Total with ESPC) | | | | | |
| Linear alcohol C9-11 | — | — | 4.5 | 4.5 | 4.5 |
| with 6 moles E.O. | | | | | |
| Sorbitol | — | 30.8 | 33.5 | 32.75 | 32.75 |
| Alkyl polyglycoside | — | — | — | 2.25 | — |
| Amine Oxide | — | — | — | — | 2.25 |
| TOTAL | 100 | 100 | 100 | 100 | 100 |

The cleaning performance of compositions in Table 3 was assessed against tenacious food soils, namely polymerized fats and proteins. To test these soils, stainless steel coupons were baked at 425° F. for 60 minutes. The baked coupons were allowed to cool, then submerged in use solutions of the use solutions of the compositions in Table 3 under heating and agitation. Gravimetric removal of the soil was calculated.

The testing of compositions according to Table 3 followed initial cleaning assessments of non-hydroxide solid alkaline cleaning compositions made from benzyl alcohol or nonionic surfactants, where the performance failed to match that of the alkaline metal hydroxide formulas. Not until compositions using benzyl alcohol in combination with the sodium percarbonate was there a significant or even synergistic boost in cleaning observed.

A cleaning boost was unexpectedly observed in the compositions containing sorbitol (a C4-C6 straight chain saturated alcohol) despite the component being added for hardening along. Instead, the sorbitol surprisingly boosted the cleaning even more keeping all of the hydrogen peroxide plus sorbitol combinations providing at least the same (or improved) cleaning compared to the alkaline metal hydroxide formulas. This combination of chemistries to clean such difficult soils that historically only alkaline metal hydroxide formulas could clean was a surprising outcome.

Thereafter screening assessments were made comparing other conventional binders, and the use of any non-C4-C6 straight chain saturated alcohol binders resulted in decreased cleaning performance below that achieved from the commercial control product using sodium and potassium hydroxides with a pH of 13.6. It was also further unexpected that the Formula 2 with the combination of sodium percarbonate and sorbitol in combination with the benzyl alcohol provided enhanced cleaning efficacy. Overall, all Formulas 1-5 provided a use solution pH about less than 11.5, which are safer to handle in the workplace compared to traditional highly alkaline hydroxide compositions.

### Example 2

Cleaning compositions suitable for heavy-duty cleaning were evaluated against various challenging soils including removal of polymerized oils, rotisserie (i.e. chicken fat) soil, and lard. These cleaning challenges are representative of alkaline responsive cleaning as they are types of baked on soils. The rotisserie removal is a more challenging test as the soils are made up of larger proteins.

The testing summarized in this example compared a commercial control (hydroxide oven cleaning tablet) to various formulations of heavy-duty cleaning compositions as summarized in Table 3. The various formulations of heavy-duty cleaning compositions of Example 2 were concentrated at a 3.5% use concentration as measured by the dilution ratio of the tablet in water.

TABLE 3

| | Commercial | | | | | | | |
|---|---|---|---|---|---|---|---|---|
| | Control | Formula 25 | Formula 27 | Formula 28 | Formula 29 | Formula 32 | Formula 33 | Formula 34 |
| Ingredient | (wt-%) | (wt-%) | (wt-%) | (wt-%) | (wt-%) | (wt-%) | (wt-%) | (wt-%) |
| Benzyl Alcohol | 0.00 | 0.00 | 0.00 | 7.77 | 8.00 | 6.00 | 0.00 | 6.00 |
| ESPC | 0.00 | 13.71 | 13.71 | 13.31 | 13.71 | 13.71 | 13.71% | 13.77 |
| Light ash | 7.00 | 39.43 | 51.90 | 34.95 | 37.40 | 37.40 | 37.40 | 37.40 |
| F108 | 0.00 | 3.50 | 1.66 | 1.66 | 1.71 | 3.50 | 3.50 | 2.00 |
| Sorbitol | 0.00 | 17.00 | 15.53 | 15.53 | 15.00 | 16.00 | 16.00 | 15.00 |
| Sodium | 0.00 | 14.06 | 0.00 | 13.65 | 14.06 | 14.06 | 14.06 | 14.00 |
| percarbonate | | | | | | | | |
| PEG 8000 | 5.00 | 5.00 | 0.00 | 0.00 | 0.00 | 3.00 | 3.00 | 0.00 |
| Potassium | 5.50 | 0.00 | 0.00 | 0.00 | 0.00 | 0.00 | 0.00 | 0.00 |
| hydroxide | | | | | | | | |
| Sodium | 77.00 | 0.00 | 0.00 | 0.00 | 0.00 | 0.00 | 0.00 | 0.00 |
| hydroxide | | | | | | | | |
| Tomadol 91-6 | 0.00 | 0.00 | 0.00 | 0.00 | 0.00 | 0.00 | 2.00 | 2.00 |
| Additional | Remainder to 100 | | | | | | | |
| Components | | | | | | | | |
| (e.g. silicate, | | | | | | | | |
| citric acid, | | | | | | | | |
| sodium | | | | | | | | |
| gluconate, | | | | | | | | |
| sodium acetate) | | | | | | | | |
| Total | 100 | 100 | 100 | 100 | 100 | 100 | 100 | 100 |

Polymerized oil cut through was tested by obtaining pre-soiled panels of 3″×5″ stainless steel with corn oil baked on. A droplet of use solution of the evaluated cleaning compositions was applied to the panel. Then, a stopwatch was started, the use solution was wiped away, and the time at which all of the soil was removed was recorded as the ‘polymerized oil cut through’ time.

Chicken fat soil removal was tested by obtaining and pre-weighing 3″×5″ 304 stainless steel coupons on an analytical balance. On each coupon, 0.25 grams of melted chicken fat was applied with a foam brush, with the soil concentrated on the lower two-thirds of the substrate. The soiled coupons were then placed on a baking sheet and baked in an oven at 425° F. for 60 minutes. The baked on soil covered the coupon surface uniformly and appeared dark amber in color. The coupons were then allowed to cool, and the soiled weight was recorded. To test the cleaning performance, a water bath was heated to a constant temperature of 60° C. Using an 800 mL beaker, 500 grams of the cleaning composition was prepared with 5 gpg water. The cleaning composition test solutions were heated in the water bath until temperature equilibrium was reached. The soiled coupons were then placed in the cleaning composition test solutions and soaked at 600 RPM for 30 minutes. Afterwards, the coupons were removed, rinsed under DI water, and let to dry overnight. The next day, the coupons were weighed, and the percentage of weight change was recorded.

Lard soil removal was tested by obtaining and pre-weighing 3″×5″ 304 stainless steel coupons on an analytical balance. Then, 0.25 grams of melted lard was applied to the coupons with a foam brush. The panel was then baked at 425° F. for 30 minutes and afterwards allowed to cool. After cooling, the weight of the soiled panel was measured and recorded. To test the cleaning performance, the soiled panel was added to 500 mL of use solution at 60° C. and 600 RPM which was allowed to stir for 30 minutes. The panel was then rinsed under laminar flow DI water and allowed to dry overnight. The next day, the weight of the panel was measured, and the difference was recorded.

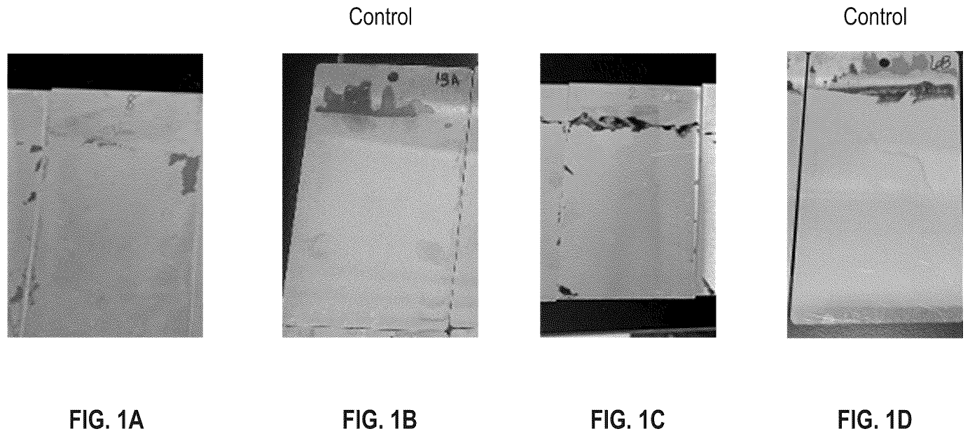

The quantitative results of the rotisserie and lard removal comparing cleaning composition of Formula 29 (pH below 11.5 to provide a PPE-free composition) to the Commercial Control are summarized in Table 4 and FIGS. 1A-D. FIGS. 1A-D show a performance comparison between the heavy-duty cleaning composition (Formula 29) and the Commercial Control. The Heavy-duty cleaning composition has a PPE-free pH (<11.5) and has equal or better performance to the more alkaline Commercial Control. FIGS. 1A and 1C show the Heavy-duty cleaning composition formula on baked on lard and rotisserie respectively, whereas FIGS. 1B and 1D show the Commercial Control on baked on lard and rotisserie respectively. The results show improved lard removal by the PPE-free Heavy-duty cleaning composition compared to the more alkaline Commercial Control and a substantially similar rotisserie removal.

TABLE 4

| Formula | pH | % Rotisserie Removed | % Lard Removed |
|---|---|---|---|
| Formula 29 | 10.75 | 92% | 95% |
| Commercial Control | 13.56 | 93% | 82% |

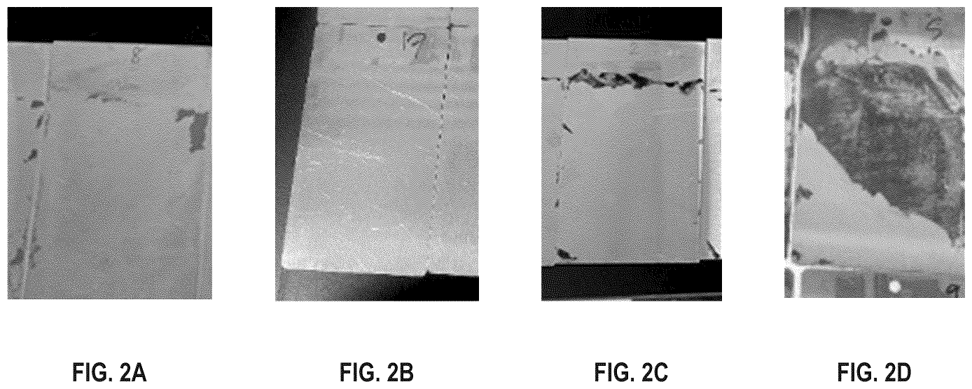

The quantitative results of the polymerized soil cut through time, rotisserie and lard removal comparing cleaning composition of Formulas 28 and 32 are summarized in Table 5 and FIGS. 2A-D. This test lowered the pH of the Heavy-duty cleaning composition through use of additional acid in the formulation. FIGS. 2A-D show a performance comparison of the Heavy-duty cleaning composition with varying pH. The results show for the more challenging rotisserie removal there is a benefit to pH greater than about 10.7. FIG. 2A shows a pH 10.75 formula on baked on lard, FIG. 2B shows a pH 10.58 formula on baked on lard, FIG. 2C shows a pH 10.75 formula on baked on rotisserie, and FIG. 2D shows a pH 10.58 formula on baked on rotisserie. There was also a benefit to having the pH>10.7 for reduced cut through time on the polymerized soil.

TABLE 5

| | | Polymerized | | |
|---|---|---|---|---|
| | | Oil Cut | % Rotisserie | % Lard |
| Formula | pH | Through (min) | Removed | Removed |
| Formula 28 | 10.58 | 3 | 46% | 93% |
| Formula 32 | 10.75 | 2 | 95% | 92% |

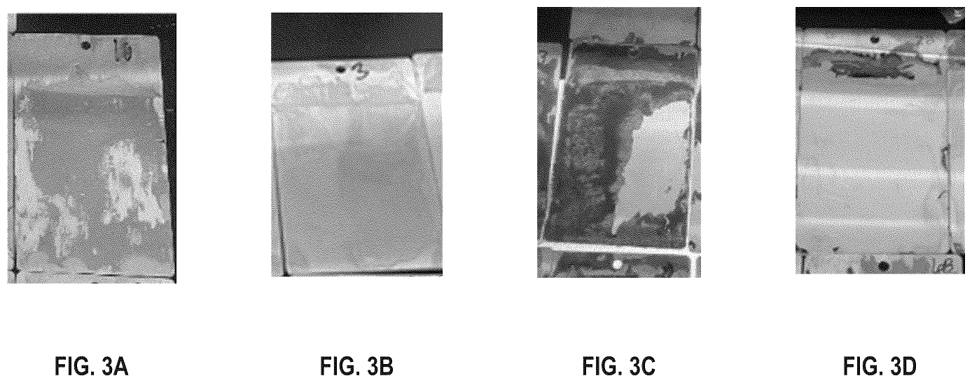

The quantitative results of the polymerized soil cut through time, rotisserie and lard removal comparing cleaning composition of Formulas 27 and 25 are shown in FIGS. 3A-D and in Table 6. FIGS. 3A-3D show a performance comparison of heavy-duty cleaning compositions having variations in formulations with sorbitol and acid with and without sodium percarbonate. Sodium percarbonate is demonstrated to provide a significant benefit to the compositions for degreasing component in the Heavy-duty cleaning compositions. Cleaning performance is shown in FIG. 3A which shows formula 27 on baked on lard, FIG. 3B which shows formula 25 on baked on lard, FIG. 3C which shows formula 27 on baked on rotisserie, and FIG. 3D which shows formula 25 on baked on rotisserie.

TABLE 6

| | | Polymerized | | |
|---|---|---|---|---|
| | | Oil Cut | % Rotisserie | % Lard |
| Formula | pH | Through (min) | Removed | Removed |
| Formula 27 | 10.75 | 2 | 8% | 52% |
| Formula 25 | 10.78 | 2 | 93% | 89% |

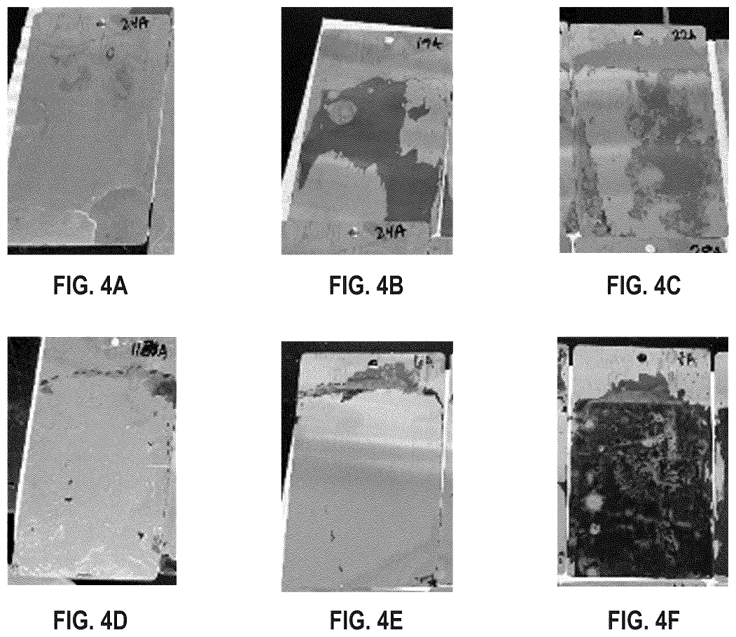

The quantitative results of the polymerized soil cut through time, rotisserie and lard removal comparing cleaning composition of Formulas 32, 33 and 34 are shown in FIGS. 4A-F and below in Table 7. FIGS. 4A-F show the degreasing behaviors of benzyl alcohol and percarbonate chemistries in the heavy-duty cleaning compositions. Benzyl alcohol is demonstrated to improve the cleaning capacity of Formula 34. Cleaning performance is shown in FIG. 4A which shows formula 32 on baked on lard, FIG. 4B which shows formula 34 on baked on lard, FIG. 4C which shows formula 33 on baked on lard, FIG. 4D which shows formula 32 on baked on rotisserie, FIG. 4E which shows formula 34 on baked on rotisserie, and FIG. 4F which shows formula 33 on baked on rotisserie.

| | | Polymerized | | |
|---|---|---|---|---|
| | | Oil Cut | % Rotisserie | % Lard |
| Formula | pH | Through (min) | Removed | Removed |
| 32 | 10.74 | 2 | 86% | 91% |
| 34 | 10.75 | 3 | 90% | 46% |
| 33 | 10.78 | 4+ | 4% | 72% |

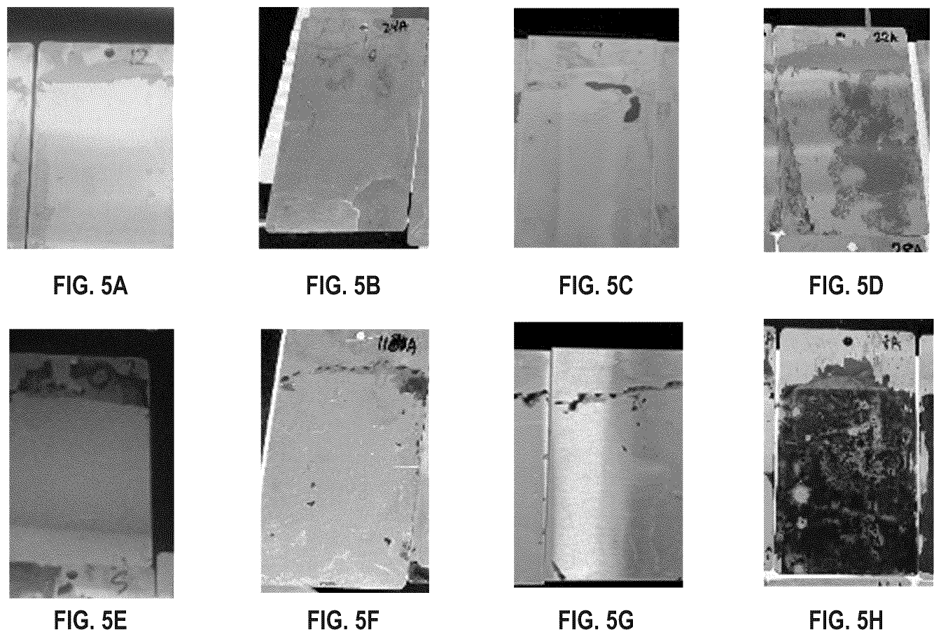

The quantitative results of the polymerized soil cut through time, rotisserie and lard removal comparing cleaning composition of Formulas 25, 29, 32 and 34 are shown in FIGS. 5A-H and in Table 8. FIGS. 5A-H show the performance of the sorbitol, percarbonate, and benzyl alcohol in cleaning compositions according to the invention. The percarbonate, sorbitol, and benzyl alcohol are shown to have a unique degreasing synergy not observed with other rigidity agents such as sodium gluconate. FIG. 5A shows formula 29 on baked on lard, FIG. 5B shows formula 32 on baked on lard, FIG. 5C shows formula 25 on baked on lard, FIG. 5D shows formula 34 on baked on lard, FIG. 5E shows formula 29 on baked on rotisserie, FIG. 5F shows formula 32 on baked on rotisserie, FIG. 5G shows formula 25 on baked on rotisserie and FIG. 5H shows formula 34 on baked on rotisserie.

TABLE 8

| | | Polymerized | | |
|---|---|---|---|---|
| | | Oil Cut | % Rotisserie | % Lard |
| Formula | pH | Through (min) | Removed | Removed |
| 29 | 10.75 | 2 | 95% | 92% |
| 32 | 10.74 | 2 | 86% | 91% |
| 25 | 10.73 | 2 | 91% | 72% |
| 34 | 10.75 | 3 | 90% | 46% |

The testing demonstrates successful cleaning at a 3.5% dilution used throughout the Example.

### Example 3

The formula described in Table 9 was assessed at a commercial site for use in heavy-duty cleaning applications.

TABLE 9

| | 6 |
|---|---|
| Components | (wt-%) |
| Tomadol 91-6 | 2.04 |
| Glucopon 425 | 1.51 |
| Plurafac SLF-180 | 0.41 |
| Light ash | 38.10 |
| ESPC | 14.25 |
| Sodium percarbonate | 14.49 |
| Sodium acetate | 5.80 |
| Sodium gluconate | 4.66 |
| Sodium Metasilicate | 0.89 |
| Trilon M | 2.07 |
| Sorbitol | 15.77 |
| Total | 100 |

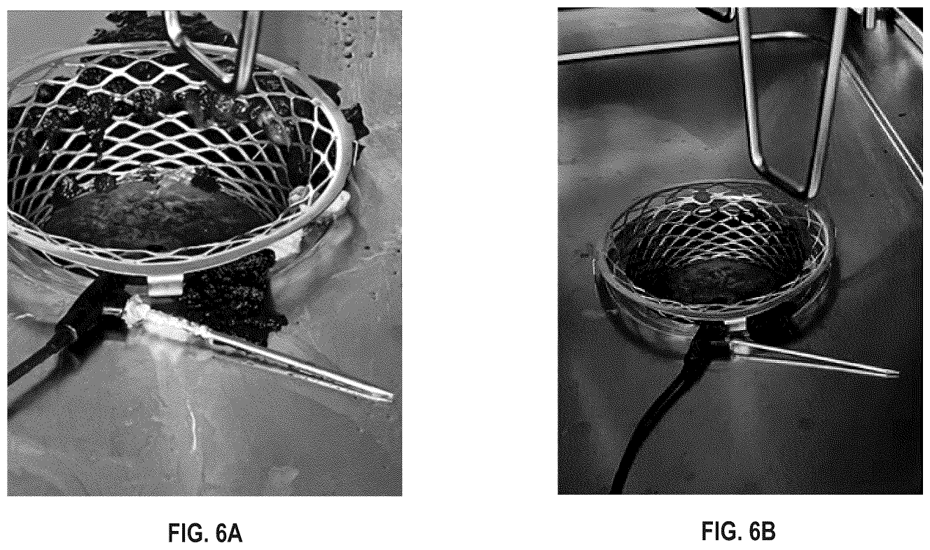

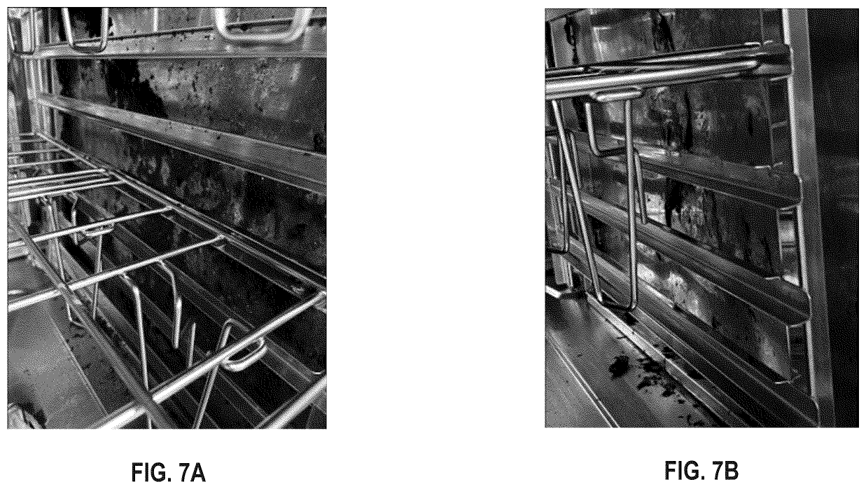

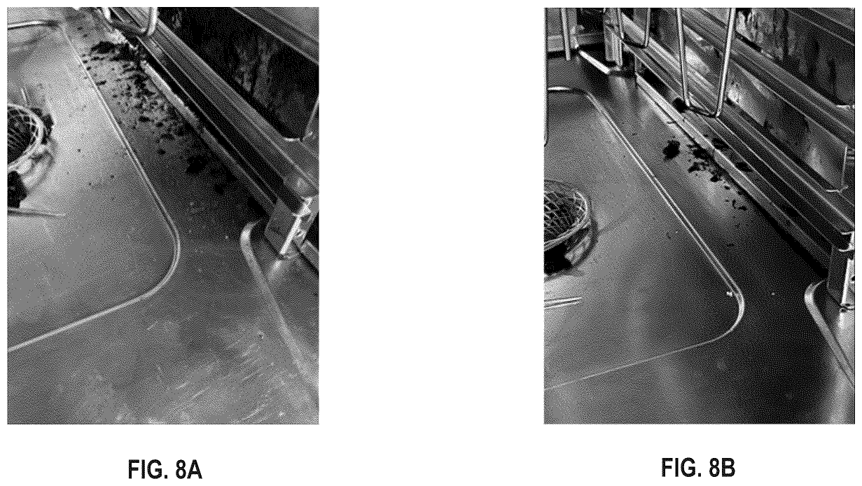

The tablet compositions were tested in a commercial oven at a retain grocery chain using a Rational iCombi Pro oven. The tablets were used in combination with a delimer product in the oven and observational comparison was made observing the tablets cleaned the polymerized oil well despite the oven cleaning cycle having operational challenges (mechanical issues) during the testing. In particular it was observed that the polymerized soils were fully removed from the grease trap (FIG. 6B compared to before FIG. 6A), baked on oils and soils form inside the oven were substantially removed (FIG. 7B compared to before FIG. 7A; and FIG. 8B compared to before FIG. 8A),

### Example 4

Additional exemplary formulas as described in Table 10 as suitable for applications of use as described for heavy-duty cleaning applications.

TABLE 10

| | Formulas | | | | |
|---|---|---|---|---|---|
| | 7 | 8 | 9 | 10 | 11 |
| Components | (wt-%) | (wt-%) | (wt-%) | (wt-%) | (wt-%) |
| ESPC | 13.77 | 13.77 | 13.71 | 13.77 | 13.77 |
| benzyl alcohol | 6.00 | — | 8.00 | — | — |
| Tomadol 91-6 | — | 3.31 | — | 2.74 | 2.74 |
| sodium carbonate | 37.00 | 37.00 | 37.40 | 37.40 | 37.40 |
| sodium percarbonate | 14.00 | 14.06 | 14.06 | 14.00 | 14.00 |
| Sorbitol | 15.00 | 16.00 | 15.00 | 15.23 | 15.23 |
| Pluronic F108 | 2.00 | 2.00 | 1.71 | 3.50 | 3.50 |
| Alkyl polyglycoside | — | — | — | 1.00 | — |
| Amine oxide | — | — | — | — | 1.00 |
| Additional functional | Remainder | Remainder | Remainder | Remainder | Remainder |
| ingredients (e.g. sodium | | | | | |
| acetate, sodium | | | | | |
| metasilicate, citric acid, | | | | | |
| sodium gluconate, chelant) | | | | | |
| TOTAL | 100 | 100 | 100 | 100 | 100 |

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A solid heavy-duty cleaning composition comprising:
a peroxygen generator;
a C4-C6 straight chain saturated alcohol;
solidification agents comprising from about 20 wt-% to about 50 wt-% of alkali metal carbonate; and
a nonionic surfactant comprising a linear alkyl alcohol alkoxylate or ethylene oxide/propylene oxide block copolymer, an alkylpolyglycoside surfactant, and/or amine oxide surfactant.

2. The composition of claim 1, wherein the peroxygen generator is a hydrogen peroxide generator.

3. The composition of claim 1, wherein the peroxygen generator comprises an alkali metal percarbonate, an expanded percarbonate alkali metal salt, alkali metal persulfate or monopersulfate, an alkaline earth metal peroxide, urea peroxide, alkali metal perborates, hydrogen peroxide, or a combination thereof.

4. The composition of claim 1, wherein the solid composition comprises from about 1 wt-% to about 40 wt-% of the peroxygen generator, from about 1 wt-% to about 20 wt-% of the C4-C6 straight chain saturated alcohol, from about 0.5 wt-% to about 5 wt-% of the nonionic surfactant, and from about 1 wt-% to about 10 wt-% of the solvent.

5. The composition of claim 1, wherein the C4-C6 straight chain saturated alcohol comprises at least one of sorbitol, mannitol, xylitol, and/or erythritol.

6. (canceled)

7. The composition of claim 1, wherein
(i) the peroxygen generator is sodium percarbonate, potassium percarbonate, sodium persulfate, potassium monopersulfate, calcium peroxide, magnesium peroxide, urea peroxide, sodium perborate, potassium perborate, hydrogen peroxide, or a combination thereof, and the C4-C6 straight chain saturated alcohol is sorbitol, or
(ii) the peroxygen generator is sodium percarbonate, potassium percarbonate, or a combination thereof, and the C4-C6 straight chain saturated alcohol is sorbitol.

8. (canceled)

9. The composition of claim 1, further comprising a solvent comprising a benzyl alcohol, benzyl alcohol alkoxylate, linear alcohol, and/or glycol ether, and/or further comprising a protease enzyme.

10. (canceled)

11. The composition of claim 1, further Comprising from about 0.1 wt-% to about 10 wt-% of a peroxycarboxylic acid generator; comprising monoacetin, diacetin, triacetin, glucose pentaacetate, lactose octaacetate, mannitol hexaacetate, sucrose octaacetate, N,N,N′N′-tetraacetylethylene-diamine (TAED), N,N,N′N′-tetraacetylmethylene-diamine (TAMD), N-acetyl glycine, N-acetyl-methionine, 6-acetamidohexanoic acid, N-acetyl-L-cysteine, 4-acetamido-phenol, N-acetyl-L-glutamine, and N,N′,N″,N′″-tetraacetyl glycoluril (TAGU), and/or lactide.

12. (canceled)

13. The composition of claim 1, wherein the peroxygen generator comprises an alkali metal percarbonate and an expanded percarbonate salt with a bulk density of about 0.62 to 0.7 g/ml and a hydrogen peroxide content of about 0.1 to 24 wt-%, and wherein the alkali metal percarbonate and the expanded percarbonate salt comprise from about 1 wt-% to about 40 wt-% of the solid composition.

14. The composition of claim 1, wherein the peroxygen generator comprises from about 20 wt-% to about 40 wt-% of the solid composition, wherein the C4-C6 straight chain saturated alcohol comprises from about 10 wt-% to about 20 wt-% of the solid composition, wherein the nonionic surfactant comprises from about 1 wt-% to about 5 wt-% of the solid composition, and wherein the solvent comprises from about 0 wt-% to about 10 wt-% of the solid composition.

15. The composition of claim 1, wherein the solid composition further comprises additional functional ingredients, and/or wherein the solid composition is a hard surface cleaner, degreaser, oven cleaner, dishwasher cleaner, drain cleaner, grease trap cleaner, washing machine cleaner, beverage tower cleaner, coffeemaker cleaner, microwave cleaner, carpet cleaner, and/or stain remover.

16. The composition of claim 1, wherein the solid composition is a granular solid, powder, flake, tablet, pellet, puck, briquette, brick, or block, and/or wherein the solid composition is a unit dose tablet or a multi-use solid block.

17. The composition of claim 1, wherein the solid composition is free of alkyl ketal esters, alkyl ether sulfates, enzymes and/or spores, alkali metal hydroxides, or combinations thereof.

18. A method of cleaning a surface or object comprising:
contacting the surface or object with a use solution of the solid heavy-duty cleaning composition of claim 1, wherein the use solution has a pH less than or about 11.5.

19. The method of claim 18, wherein the use solution is from about 10.7 to about 11.5.

20. The method of claim 18, wherein the surface comprises a hard surface, an oven, a dishwasher, a drain, a grease trap, a washing machine, a beverage tower, a coffeemaker, a microwave, a carpet or other soiled surface, a ware, or combinations thereof, and/or wherein the object is in contact with the surface.

21. The method of claim 18, wherein the use solution is generated by dissolving the solid composition in water, and wherein the use solution (i) is between about 0.5 oz/gal to about 12 oz/gal to provide desired efficacy against various heavy-duty soils, (ii) is from about 2% to about 10% use dilution of the solid composition, and/or (iii) comprises from about 3,900 ppm to about 93.750 ppm of the solid heavy-duty cleaning composition.

22. (canceled)

23. The method of claim 21, wherein the use solution is generated in a container that is subsequently used to dispense or otherwise apply the use solution to the surface or object.

24. The method of claim 18, further comprising rinsing the surface with water.

25. The method of claim 18, wherein the heavy-duty cleaning composition provides substantially similar or improved cleaning performance to a cleaning composition having an alkaline pH above about 11.5, requiring use of personal protective equipment (PPE), and/or not including the synergistic combination of the peroxygen generator and the C4-C6 straight chain saturated alcohol.
